(19) United States
(12) Patent Application Publication
(10) Pub. No.: US 2022/0131248 A1
(43) Pub. Date: Apr. 28, 2022

(54) FILTER DEVICE

(71) Applicant: FUJIKURA LTD., Tokyo (JP)

(72) Inventor: Yusuke Uemichi, Sakura-shi (JP)

(73) Assignee: FUJIKURA LTD., Tokyo (JP)

(21) Appl. No.: 17/429,411

(22) PCT Filed: Mar. 11, 2020
(86) PCT No.: PCT/JP2020/010574

§ 371 Date: Aug. 9, 2021

(30) Foreign Application Priority Data
Mar. 14, 2019 (JP) 2019-047556

(51) Int. Cl. H01P 1/207; H01P 3/12; H01P 7/06

(52) U.S. Cl. CPC H01P 1/207; H01P 7/06; H01P 3/12

(57) ABSTRACT

Provided is a filter device that includes a post-wall waveguide and that has a variable passband. This filter device (1) includes: a post-wall waveguide (filter main body 1M) that functions as a plurality of resonators (10 to 50); cavities (cylinders 551 to 555) coupled to the respective resonators (10 to 50) via openings (AP1 to AP5) formed in a broad wall (conductor layer 2); rods (61 to 65) inserted into the cavities (cylinders 551 to 555); and a rod control mechanism (piezoelectric element 6P) that controls the positions of the rods (61 to 65).

### TECHNICAL FIELD

The present invention relates to a filter device that includes a post-wall waveguide and that is a variable filter device having a variable passband.

### BACKGROUND ART

Patent Literature 1 discloses a filter device that has a passband corresponding to a part of a band of centimeter waves. In Patent Literature 1, the filter device is referred to as a “tunable filter”. The filter device includes a hollow waveguide employed as a waveguide in which a centimeter wave is guided, and a movable mechanism provided in the hollow waveguide tube in order to cause a change in the passband.

Meanwhile, a post-wall waveguide is known as a different type of waveguide than hollow waveguide tubes. For example, Non-Patent Literature 1 discloses a filter device that is a resonator-coupled filter device in which a plurality of resonators are coupled together in series and that includes a post-wall waveguide functioning as the plurality of resonators. The filter device has a passband that is a part of a band of millimeter waves.

A post-wall waveguide includes a dielectric substrate, a pair of conductor layers, and a post wall. The pair of conductor layers are provided on the respective main surfaces of the dielectric substrate so as to sandwich the dielectric substrate therebetween. The post wall is provided inside the dielectric substrate and is constituted by a plurality of conductor posts in a palisade arrangement. The plurality of conductor posts are electrically connected to each of the pair of conductor layers. Determining a gap between adjacent conductor posts among the plurality of conductor posts as appropriate allows the post wall to behave like a two-dimensionally continuous conductor wall. In the post-wall waveguide, a region surrounded on all four sides by the pair of conductor layers and the post wall functions as a waveguide region. In the filter device disclosed in Non-Patent Literature 1, a partition wall constituted by post walls partitions off a waveguide region, so that a resonance region of each resonator is formed.

The post-wall waveguide thus configured can have a reduced size and weight and can be manufactured at a lower cost, in comparison to a hollow waveguide tube.

### CITATION LIST

### Patent Literature

[Patent Literature 1] Japanese Patent Application Publication Tokukai No. 2011-9806

### Non-Patent Literature

[Non-patent Literature 1] Yusuke Uemichi, et. al., “Compact and Low-Loss Bandpass Filter Realized in Silica-Based Post-Wall Waveguide for 60-GHz applications”, IEEE, MTT-S IMS, May 2015.

### SUMMARY OF INVENTION

### Technical Problem

However, in the foregoing filter device including the post-wall waveguide, an inside of the waveguide region is filled with a dielectric which constitutes a part of the dielectric substrate. As such, a movable mechanism for causing a change in passband as described in Patent Literature 1 cannot be provided inside the waveguide region.

The present invention was made in view of the above issues, and an objective thereof is to provide a filter device that includes a post-wall waveguide and that has a variable passband.

### Solution to Problem

In order to attain the objective, a filter device in accordance with an aspect of the present invention is a filter device, including: a post-wall waveguide that functions as a resonator group constituted by a plurality of resonators electromagnetically coupled together and that includes: a dielectric substrate; a first conductor layer and a second conductor layer that are a pair of broad walls and provided on a first main surface and a second main surface, respectively, of the dielectric substrate; and a post wall passing through the dielectric substrate and constituted by a conductor post group which is a plurality of conductor posts arranged in a palisade arrangement and via which the first conductor layer and the second conductor layer are in electrical communication with each other, a resonance region of each of the plurality of resonators being formed by the first conductor layer, the second conductor layer, and a part of the dielectric substrate which part is surrounded by the post wall; an opening formed in one of the pair of broad walls of each of at least one resonator belonging to the resonator group; a cavity electromagnetically coupled to each of the at least one resonator via the opening; a rod inserted into the cavity from an end part of the cavity which end part faces away from the opening, at least an end surface of the rod on an opening side being made of a conductor; and a rod control mechanism that controls a gap between the end surface of the rod and a main surface close to the opening.

### Advantageous Effects of Invention

A filter device in accordance with an aspect of the present invention makes it possible to provide a filter device that includes a post-wall waveguide and that has a variable passband.

### BRIEF DESCRIPTION OF DRAWINGS

FIG. 1 is a perspective view of a filter device in accordance with an embodiment of the present invention.

FIG. 2 is an exploded perspective view of the filter device illustrated in FIG. 1.

FIG. 3 is a plan view schematically illustrating contours of five resonators of the filter device illustrated in FIG. 1.

FIG. 4 is a cross-sectional view of one of the five resonators illustrated in FIG. 3.

FIG. 5 is a cross-sectional view of one of five resonators of a Variation of the filter device illustrated in FIG. 1.

(a) of FIG. 6 is a chart showing transmission characteristics obtained using a filter device that is Example 1 of the present invention. (b) of FIG. 6 is a chart showing transmission characteristics obtained using a filter device that is Example 2 of the present invention.

### DESCRIPTION OF EMBODIMENTS

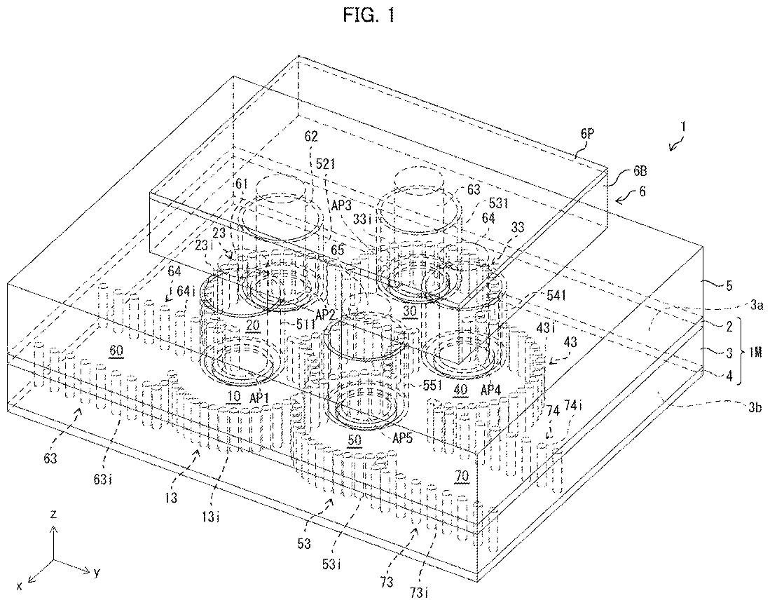

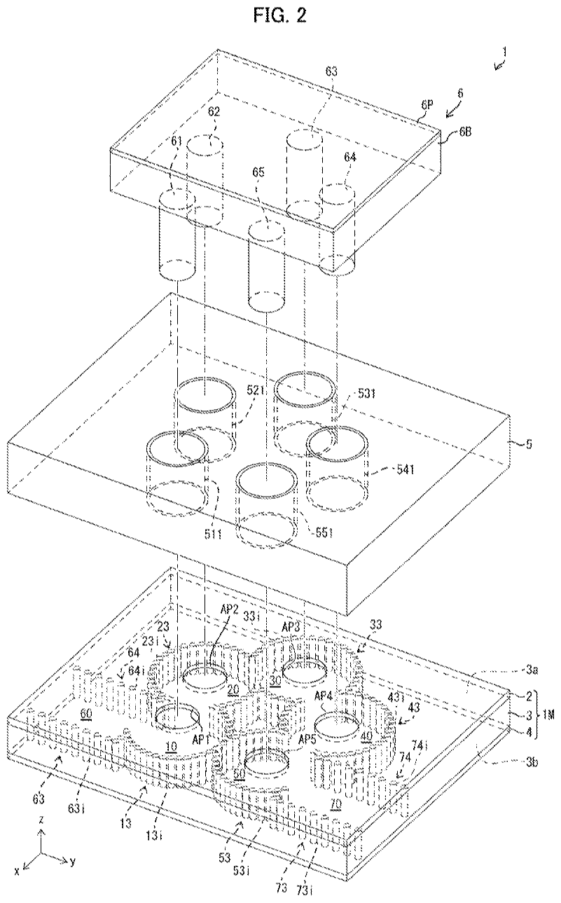

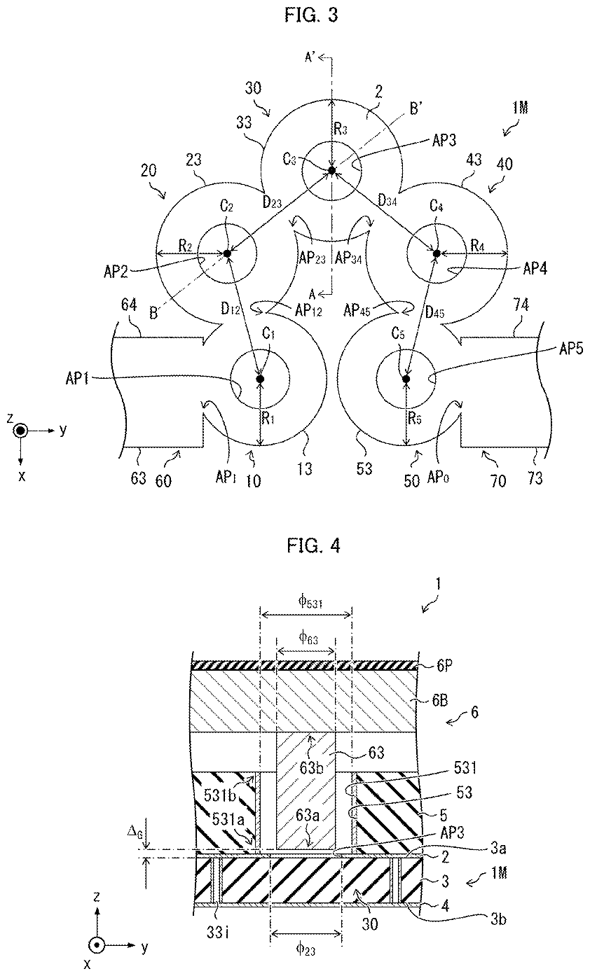

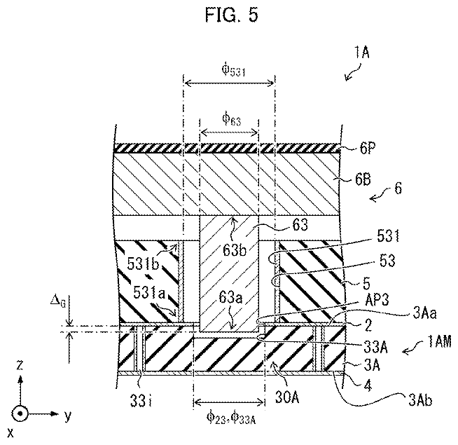

The following description will discuss a filter device 1 in accordance with an embodiment of the present invention with reference to FIGS. 1 to 4. FIG. 1 is a perspective view of the filter device 1. FIG. 2 is an exploded perspective view of the filter device 1. FIG. 3 is a plan view schematically illustrating contours of five resonators 10 to 50 of the filter device 1. Note that, in FIG. 3, post walls 13, 23, 33, 43, 53, 63, 64, 73, and 74, each of which is constituted by a conductor post group, are each illustrated in the form of an imaginary continuous conductor wall. FIG. 4 is a cross-sectional view of the resonator 30 illustrated in FIG. 3, taken along the line A-A′ indicated in FIG. 3.

As illustrated in FIGS. 1 and 2, the filter device 1 includes a filter main body 1M, a block 5, and a rod control unit 6. The filter main body 1M includes a conductor layer 2, a dielectric substrate 3, a conductor layer 4, and the post walls 13, 23, 33, 43, 53, 63, 64, 73, and 74.

The dielectric substrate 3 is made of quartz glass in the present embodiment.

In the present embodiment, the conductor layer 2 is a conductor layer made of copper and provided on a first main surface 3a which is a main surface of the dielectric substrate 3 and which is positioned downstream in the positive z axis direction. In the present embodiment, the conductor layer 4 is a conductor layer made of copper and provided on a second main surface 3b which is a main surface of the dielectric substrate 3 and which is positioned downstream in the negative z axis direction.

Each of the post walls 13, 23, 33, 43, 53, 63, 64, 73, and 74 passes through the dielectric substrate 3 and consists of a conductor post group which is constituted by a plurality of conductor posts via which the conductor layer 2 and the conductor layer 4 are in electrical communication with each other. As illustrated in FIGS. 1 and 2, the post wall 13 is constituted by a plurality of conductor posts 13i (i is a positive integer).

The conductor posts 13i are formed by forming through-holes that pass through the dielectric substrate 3 from the first main surface 3a to the second main surface 3b and then forming a conductor layer on an inner wall of each of the through-holes. Note that the conductor posts 13i may be formed by filling the through-holes with a conductor.

As with the post wall 13, the post walls 23, 33, 43, 53, 63, 64, 73, and 74 are respectively constituted by pluralities of conductor posts 23i, 33i, 43i, 53i, 63i, 64i, 73i, and 74i which are each arranged in a palisade arrangement.

Each of the post walls 13, 23, 33, 43, 53, 63, 64, 73, and 74, which is constituted by a plurality of conductor posts arranged at certain intervals in a palisade arrangement, functions as a kind of conducting wall that reflects electromagnetic waves within a band that depends on the certain intervals.

[Filter Main Body 1M]

As illustrated in FIGS. 1 to 3, the filter main body 1M includes the resonators 10, 20, 30, 40, and 50 constituting a resonator group and waveguides 60 and 70. Each of these resonators 10, 20, 30, 40, and 50 and waveguides 60 and 70 is a post-wall waveguide which is formed by: a part of the conductor layer 2 and a part of the conductor layer 4 serving as a pair of broad walls; and a corresponding one(s) of the post walls 13, 23, 33, 43, 53, 63, 64, 73, and 74 serving as a narrow wall(s), and in which a region surrounded by the pair of broad walls and the narrow wall(s) functions as a waveguide region.

For example, the post wall 13 of the resonator 10 is constituted by the plurality of conductor posts 13i arranged in a circle in a palisade arrangement. Similarly, the post walls 23, 33, 43, and 53 of the resonators 20, 30, 40, and 50 are respectively constituted by the pluralities of conductor posts 23i, 33i, 43i, and 53i each arranged in a circle in a palisade arrangement, and the post walls 63, 64, 73, and 74 of the waveguides 60 and 70 are respectively constituted by the pluralities of conductor posts 63i, 64i, 73i, and 74i each arranged in a straight line in a palisade arrangement.

As a result, for example, a main resonance region of the resonator 30 is constituted by a part of the conductor layer 2, a part of the conductor layer 4, and a part of the dielectric substrate 3 surrounded by the post wall 33, as illustrated in FIG. 4. Similarly, a main resonance region of each of the resonators 10, 20, 40, and 50 is constituted by a part of the conductor layer 2, a part of the conductor layer 4, and a part of the dielectric substrate 3 surrounded by a corresponding one of the post walls 13, 23, 43, and 53.

Note that the conductor layer 2 has a circular opening AP1 in a region that includes a center C₁ of a region that functions as a broad wall of the resonator 10 (see FIG. 3). Similarly, the conductor layer 2 has: a circular opening AP2 in a region that includes a center C₂ of a region that functions as a broad wall of the resonator 20; a circular opening AP3 in a region that includes a center C₃ of a region that functions as a broad wall of the resonator 30; a circular opening AP4 in a region that includes a center C₄ of a region that functions as a broad wall of the resonator 40; and a circular opening AP5 in a region that includes a center C₅ of a region that functions as a broad wall of the resonator 50.

The waveguide 60 and the resonator 10 are electromagnetically coupled together via a coupling window AP_{I}. The resonator 10 and the resonator 20 are electromagnetically coupled together via a coupling window AP₁₂. The resonator 20 and the resonator 30 are electromagnetically coupled together via a coupling window AP₂₃. The resonator 30 and the resonator 40 are electromagnetically coupled together via a coupling window AP₃₄. The resonator 40 and the resonator 50 are electromagnetically coupled together via a coupling window AP₄₅. The resonator 50 and the waveguide 70 are electromagnetically coupled together via a coupling window APₒ.

The coupling window AP₁₂ is formed by missing one(s) of the conductor posts 13i and one(s) of the conductor posts 23i. The coupling windows AP₂₃, AP₃₄, AP₄₅, AP_{I}, and APₒ are each formed in a similar fashion.

In the filter main body 1M, each of the coupling windows AP_{I} and APₒ functions as an input-output port. When the coupling window AP₁ serves as an input port, the coupling window APₒ serves as an output port, whereas, when the coupling window APₒ serves as an input port, the coupling window AP_{I} serves as an output port. Either of the input-output ports can be used as an input port; however, in the description of the present embodiment, the coupling window AP_{I} serves as an input port and the coupling window APₒ serves as an output port. That is, the resonator 10 corresponds to the “first-pole resonator” recited in the Claims, and the resonator 50 corresponds to the “last-pole resonator” recited in the Claims.

As described above, the filter main body 1M is a post-wall waveguide that functions as a five-pole, resonator-coupled bandpass filter in which the five resonators 10, 20, 30, 40, and 50 are electromagnetically coupled.

In the above description of the present embodiment, the filter main body 1M includes the five resonators 10, 20, 30, 40, and 50. Note that the number of resonators of the filter main body 1M does not necessarily need to be five but can be selected as appropriate depending on the desired filter characteristics.

(Center-to-Center Distance Between Resonators)

As illustrated in FIG. 3, the radius of each of the broad walls forming the resonator 10 is referred to as R₁, the radius of each of the broad walls forming the resonator 20 is referred to as R₂, the radius of each of the broad walls forming the resonator 30 is referred to as R₃, the radius of each of the broad walls forming the resonator 40 is referred to as R₄, and the radius of each of the broad walls forming the resonator 50 is referred to as R₅. Furthermore, the distance between the center C₁ and the center C₂ is referred to as D₁₂, the distance between the center C₂ and the center C₃ is referred to as D₂₃, the distance between the center C₃ and the center C₄ is referred to as D₃₄, and the distance between the center C₄ and the center C₅ is referred to as D₄₅. Note that, as described later, outer edges of the broad walls of each of the resonators 10, 20, 30, 40, and 50 are each in a circular shape. As such, the circumcircles of the broad walls coincide with the outer edges of the broad walls, respectively. Further, in a case where the outer edges of the broad walls of the resonators 10, 20, 30, 40, and 50 are each in the shape of a regular polygon with six or more vertices instead of a circle, the foregoing radii R1, R2, R3, R4, and R5 can be defined with use of the radii of the regular polygonal circumcircles of the broad walls of the respective resonators 10, 20, 30, 40, and 50.

In the above arrangement, the radius R₁, the radius R₂, and the distance D₁₂ satisfy the condition D₁₂<R₁+R₂, the radius R₂, the radius R₃, and the distance D₂₃ satisfy the condition D₂₃<R₂+R₃, the radius R₃, the radius R₄, the distance D₃₄ satisfy the condition D₃₄<R₃+R₄, and the radius R₄, the radius R₅, and the distance D₄₅ satisfy the condition D₄₅<R₄+R₅. Provided that such a condition is satisfied, two adjacent resonators (for example, the resonator 10 and the resonator 20) can be electromagnetically coupled to each other via a coupling window in the narrow walls of the resonators (for example, via the coupling window AP₁₂).

(Symmetry of Two Adjacent Resonators)

Of the plurality of resonators 10, 20, 30, 40, and 50 in the filter main body 1M, a focus is placed on two adjacent resonators coupled to each other. The following description is based on the resonator 20 and the resonator 30. The shape of a combination of each of the broad walls of one of the two resonators 20 and 30 and each of the broad walls of the other of the two resonators 20 and 30 is symmetric with respect to line BB′ that connects the centers C₂ and C₃ together (see FIG. 3). As such, the degree of symmetry of the two resonators coupled to each other in the filter main body 1M is high. This makes it possible to reduce the number of design parameters. Thus, the filter main body 1M makes it possible to easily design a bandpass filter with desired characteristics.

Note that, in the filter main body 1M, not only two resonators coupled to each other but also the filter device 1 as a whole is symmetric with respect to a line. Specifically, the resonators 10 to 50 are arranged such that they are symmetric with respect to a line that is parallel to the x axis and that passes through the center C₃ of the region that functions as broad walls of the resonator 30, and the waveguides 60 and 70 are arranged such that they are symmetric with respect to that line. As such, the filter main body 1M has a high degree of symmetry also concerning the shape of the filter main body 1M as a whole. This makes it possible to further reduce the number of design parameters. Thus, the filter main body 1M makes it possible to more easily design a bandpass filter with desired characteristics.

(Arrangement of Resonators 10 and 50)

In the filter main body 1M, the resonator 10 and the resonator 50 are arranged so as to be adjacent to each other (see FIG. 3). Therefore, the total length of the filter main body can be reduced as compared to when a plurality of resonators are arranged in a straight line. A reduction in total length of the filter main body makes it possible to reduce the absolute value of thermal expansion or thermal contraction that would result from a change in ambient temperature around the filter main body 1M. As such, the filter main body 1M, whose total length is shorter than that of the conventional filter main body, is capable of reducing changes in center frequency of a passband, bandwidth, and the like that would result from changes in ambient temperature. In other words, the characteristics of the filter main body 1M are highly stable to changes in ambient temperature.

(Shapes of Resonators)

As illustrated in FIGS. 1 to 3, in the resonators 10, 20, 30, 40, and 50 of the filter main body 1M, the pluralities of conductor posts 13i, 23i, 33i, 43i, and 53i of the post walls 13, 23, 33, 43, and 53 serving as narrow walls are each arranged in a palisade arrangement along the circle when the first main surface 3a is seen in a plan view. In this case, outer edges of the pair of broad walls of each of the resonators 10, 20, 30, 40, and 50 are each in a circular shape. Note that each of the pluralities of conductor posts 13i, 23i, 33i, 43i, and 53i may be arranged in a palisade arrangement along a regular polygon with six or more vertices instead of the circle. In this case, outer edges of the pair of broad walls of the respective resonators 10, 20, 30, 40, and 50 are each in the shape a regular polygon with six or more vertices instead of a circle.

In a filter device in accordance with an aspect of the present invention, in a case where the resonators of the filter main body 1M are arranged in a straight line, the conductor posts of the post wall serving as the narrow wall of each of the resonators may be arranged in a palisade arrangement along a rectangle.

[Configuration for Causing Change in Volume of Resonance Region]

As described above, the openings AP1, AP2, AP3, AP4, and AP5 are each formed in a region of the conductor layer 2 which region functions as a broad wall of a corresponding one of the resonators 10, 20, 30, 40, and 50 (see FIG. 3). The filter device 1 includes: the filter main body 1M, in which the openings AP1, AP2, AP3, AP4, and AP5 are thus formed in the conductor layer 2; cylinders 511, 521, 531, 541, and 551 each of which is made of a conductor; rods 61, 62, 63, 64, and 65 each of which is made of a conductor; and a piezoelectric element 6P. This allows the filter device 1M to change the volume of a resonance region of each of the resonators 10, 20, 30, 40, and 50 and thus change the passband of a bandpass filter device. Note that each of the cylinders 511, 521, 531, 541, and 551 is an example of the “cavity” recited in the Claims, and the piezoelectric element 6P is an example of the “rod control mechanism” recited in the Claims. In an aspect of the present invention, the rod control mechanism is not limited to the piezoelectric element 6P, and may be any mechanism that is capable of accurately controlling the positions of the rods 61, 62, 63, 64, and 65. Other examples of the rod control mechanism include a z-axis stage that includes a micrometer.

The following description will focus on the resonator 30 out of the resonators 10, 20, 30, 40, and 50 to discuss a configuration for changing the volume of a resonance region. The configuration for changing the volume of a resonance region is provided similarly for each of the resonators 10, 20, 30, 40, and 50.

As with the dielectric substrate 3, the block 5 is a plate-shaped member made of quartz glass. The material and thickness of the block 5 is not particularly limited and can be determined as appropriate.

The block 5 has a through-hole 53 that is formed in a position corresponding to the opening AP3 in a plan view of the block 5 and that passes through the block 5 from one main surface of the block 5 to the other main surface of the block 5. The diameter of the through-hole 53 can be designed as appropriate. In the present embodiment, the diameter of the through-hole 53 is greater than the diameter φ₂₃ of the opening AP3 and smaller than the diameter (2×R₃) of the resonator 30. A conductor layer is formed on the entire surface of an inner wall of the through-hole, so that the cylinder 531 made of a conductor is disposed on the filter main body 1M.

The cylinder 531 is provided on the conductor layer 2 so that: an inside of the cylinder 531 and an inside (i.e., a main resonance region) of the resonator 30 communicate with each other via a first end part 531a of the cylinder 531 and the opening AP3; and the first end part 531a is in close contact with the conductor layer 2. That is, the cylinder 531 is electromagnetically coupled to the resonator 30 via the opening AP3. In the present embodiment, the arrangement described above is achieved by disposing the block 5, in which the cylinder 531 has been formed, on the conductor layer 2.

The rod control unit 6 includes: the rods 61, 62, 63, 64, and 65 which are made of a conductor and correspond to the resonators 10, 20, 30, 40, and 50, respectively; a plate-shaped member 6B to which the respective other end surfaces of the rods 61, 62, 63, 64, and 65 are bonded; and the piezoelectric element 6P disposed on the plate-shaped member 6B. In the present embodiment, in such a manner as to allow respective one end surfaces (end surfaces of the rods 61, 62, 63, 64, and 65 on a side close to the first main surface 3a) of the rods 61, 62, 63, 64, and 65 to be flush with one another, the respective other end surfaces of the rods 61, 62, 63, 64, and 65 are joined to the plate-shaped member 6B.

In the present embodiment, the rods 61, 62, 63, 64, and 65 are each made of copper, the plate-shaped member 6B is made of copper, and the piezoelectric element 6P is made of a piezoelectric ceramic. In an aspect of the present invention, it is only necessary that at least end surfaces (end surfaces positioned downstream in the negative z axis direction) of the rods 61, 62, 63, 64, and 65 which end surfaces face the respective openings AP1, AP2, AP3, AP4, and AP5 be made of a conductor. Further, it is preferable that a side surface of each of the rods 61, 62, 63, 64, and 65 be covered with a conductor. In such cases, the rest of the rods 61, 62, 63, 64, and 65 may be made of any material that is a solid. Further, as in the present embodiment, a whole of each of the rods 61, 62, 63, 64, and 65 may be made of a conductor (in the present embodiment, copper). Further, the material of the plate-shaped member 6B is not particularly limited, and may be selected as appropriate from existing materials. In a case where not only the rods 61, 62, 63, 64, and 65 but also the plate-shaped member 6B is made of a conductor as in the present embodiment, it is easy to achieve a short circuit between each of the rods 61, 62, 63, 64, and 65 and each of the conductor layers 2 and 4.

The rod 63 corresponding to the resonator 30 and the cylinder 531 is inserted into the cylinder 531 from a second end part 531b of the cylinder 531. More specifically, the rod 63 is arranged such that one end surface 63a of the rod 63 is inserted into the cylinder 531 from the second end part 531b of the cylinder 531 and a gap Δ_{G} between the one end surface 63a and the first main surface 3a of the dielectric substrate 3 is a predetermined gap.

The piezoelectric element 6P is a solid state component whose volume can be reversibly changed by changing a voltage applied to the respective terminals of the solid state component. As such, in the filter device 1, a voltage applied to the respective terminals of the piezoelectric element 6P is controlled, so that the piezoelectric element 6P changes the position of the rod 63 along the z axis shown in FIG. 4. In other words, in the filter device 1, controlling a voltage applied to the respective terminals of the piezoelectric element 6P allows the piezoelectric element 6P to control the gap Δ_{G}.

As described above, a main resonance region of the resonator 30 is constituted by a part of the conductor layer 2, a part of the conductor layer 4, and a part of the dielectric substrate 3 surrounded by the post wall 33. However, the conductor layer 2 has the circular opening AP3 in a region that functions as a broad wall of the resonator 30 and that includes the center C₃. With this configuration, the resonator 30 does not fully function as a resonator constituting a resonator-coupled bandpass filter.

However, as described above, the filter device 1 includes the cylinder 531 and the rod 63 corresponding to the resonator 30. The cylinder 531 and the rod 63 each function as part of the narrow wall and the broad walls of the resonator 30. As such, in the filter device 1, the resonator 30 functions as a resonator constituting a resonator-coupled bandpass filter, even though the conductor layer 2 has the opening AP3.

Further, since the piezoelectric element 6P can control the gap Δ_{G} accurately, the filter device 1 can change the passband of the filter device 1.

(Number of Resonators Having Opening)

In the above description of the present embodiment, the resonators 10, 20, 30, 40, and 50 of the filter main body 1M have the respective openings AP1, AP2, AP3, AP4, and AP5 formed in the conductor layer 2. However, in an aspect of the present invention, which one(s) of the resonators 10, 20, 30, 40, and 50 of the filter main body 1M has/have an opening formed in the conductor layer 2 can be determined as appropriate. In an aspect of the present invention, the number of resonators having an opening may be one, or may be more than one.

(Conductor Layer in which Opening is Formed)

In the above description of the present embodiment, the filter main body 1M is configured such that the openings AP1, AP2, AP3, AP4, and AP5 are each formed in a part of the conductor layer 2 which part constitutes one of the broad walls of a corresponding one of the resonators 10, 20, 30, 40, and 50.

However, in an aspect of the present invention, each of the openings AP1, AP2, AP3, AP4, and AP5 needs only be formed at least in one of a part of the conductor layer 2 (first conductor layer) and a part of the conductor layer 4 (second conductor layer) which parts constitute the pair of broad walls of a corresponding one of the resonators 10, 20, 30, 40, and 50. In a case of forming one(s) of the openings AP1, AP2, AP3, AP4, and AP5 in the conductor layer 4, the same arrangement as the cylinder 531 and the rod 63 illustrated in FIG. 4 may be provided on a conductor layer 4 side (positioned downstream in the negative z axis direction) with respect to the dielectric substrate 3 so as to correspond to the opening(s) formed in the conductor layer 4.

[Variation]

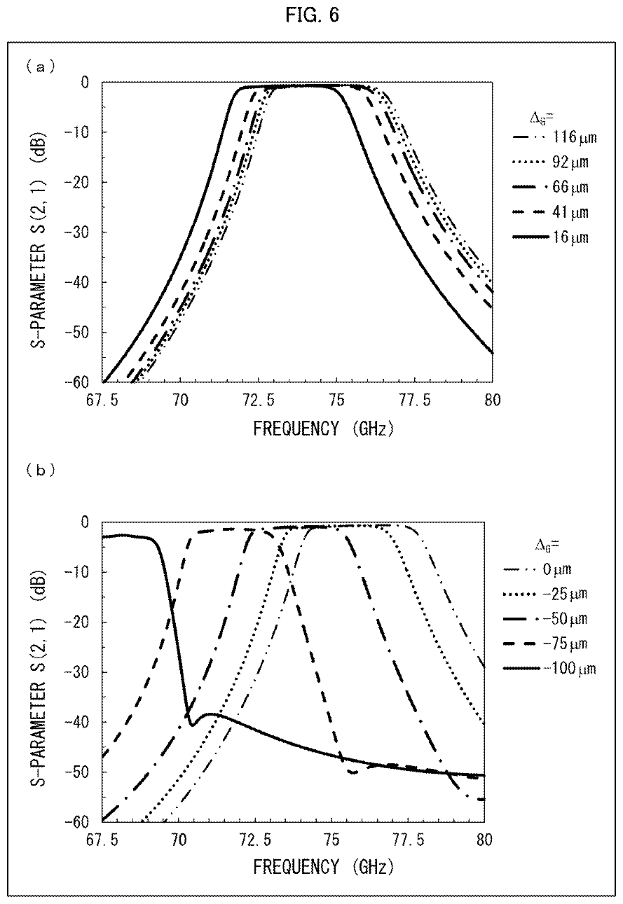

The following description will discuss, with reference to FIG. 5, a filter device 1A which is a variation of the filter device 1. FIG. 5 is a cross-sectional view of a resonator 30A out of resonators 10A, 20A, 30A, 40A, and 50A included in the filter device 1A.

The filter device 1A is obtained by replacing the dielectric substrate 3 of the filter device 1 with a dielectric substrate 3A. As such, out of the members constituting the filter device 1A, members identical to members of the filter device 1 will be given identical reference signs, and description of such members will be omitted. That is, in the present variation, description of a conductor layer 2, a conductor layer 4, a block 5, and a rod control unit 6 will be omitted, and description will be given only on the dielectric substrate 3A. Further, in the following description of the present variation, the filter device 1A will be discussed by focusing on the resonator 30A as an example among the resonators 10A, 20A, 30A, 40A, and 50A, as in the description of the filter device 1 of the foregoing embodiment.

Note that the resonator 30A of the filter device 1A corresponds to the resonator 30 of the filter device 1. The resonators 10A, 20A, 40A, and 50A of the filter device 1A respectively correspond to the resonators 10, 20, 40, and 50 of the filter device 1. In the present variation, the resonators 10A, 20A, 40A, and 50A are not illustrated in the drawings.

As illustrated in FIG. 5, in the filter device 1A, a part of the dielectric substrate 3A which part forms a resonance region of the resonator 30 has, on a first main surface 3Aa of the part of the dielectric substrate 3A, a recess 33A that is formed in a position close to an opening AP3 so as to be recessed from the first main surface 3Aa into the resonance region of the resonator 30. That is, the recess 33A is recessed from the first main surface 3Aa into the resonance region. In a plan view of the first main surface 3Aa, the recess 33A has an outer edge within which an outer edge of one end surface 63a of a rod 63 is contained. In the present variation, the recess 33A has a circular outer edge and a diameter φ_{33A} equal to the diameter φ₂₃ of the opening AP₃ and greater than the diameter φ₆₃ of the rod 63.

Note that the outer edge of the recess 33A is not limited to a circular shape and can be designed as appropriate. The depth of the recess 33A can also be designed as appropriate.

In the present variation, also parts of the dielectric substrate 3A which parts form resonance regions of the respective resonators 10A, 20A, 40A, and 50A each have a recess, which is similar to the recess 33A of the resonator 30A, in a position close to a corresponding one of openings AP1, AP2, AP4, and AP5. That is, a recess similar to the recess 33A is formed in each of the resonators 10A, 20A, 40A, and 50A. Note that, in an aspect of the present invention, the recess may be formed only in one(s) of a plurality of resonators. Which resonator(s) to form the recess in can be designed as appropriate. For example, in an aspect of the present invention, the resonators 10A, 30A, and 50A each having a recess (see FIG. 5) and the resonators 20 and 40 each having no recess (see FIG. 4) may be provided. In this case, the rod control unit 6 only needs to be capable of controlling the positions of rods 61, 63, and 65 and the positions of rods 62 and 64.

[Examples of Filter Device 1 and Filter Device 1A]

As an Example of the filter device 1 configured as illustrated in FIGS. 1 to 4, the diameter of each of the openings corresponding to the resonators 10, 20, 30, 40, and 50 (for example, the diameter φ₂₃ of the opening AP3 in a case of the resonator 30) was set to 600 μm, the inner diameter of each of the cylinders corresponding to the resonators 10, 20, 30, 40, and 50 (for example, the inner diameter φ₃₁ of the cylinder 531 in a case of the resonator 30) was set to 800 μm, and the diameter of each of the rods corresponding to the resonators 10, 20, 30, 40, and 50 (for example, the diameter φ₆₃ of the rod 63 in a case of the resonator 30) was set to 400 μm. Then, the gap Δ_{G} in the Example of the filter device 1 was set such that Δ_{G}=16 μm, 41 μm, 66 μm, 91 μm, and 116 μm, and the frequency dependence of S-parameter S(2, 1) of the Example of the filter device 1 was simulated. Hereinafter, frequency dependence of S-parameter S(2, 1) may also be referred to as transmission characteristics. (a) of FIG. 6 shows the transmission characteristics of the Example of the filter device 1. Note that the gap Δ_{G} is positive in a case where one end surface (for example, the one end surface 63a in a case of the resonator 30) of each of the rods corresponding to the resonators 10, 20, 30, 40, and 50 is positioned downstream in the positive z axis direction with respect to the first main surface 3a, and the gap Δ_{G} is negative in a case where the one end surface is positioned downstream in the negative z axis direction with respect to the first main surface 3a.

With reference to (a) of FIG. 6, it was found that the passband of the Example of the filter device 1 can be shifted toward a high frequency side by increasing the gap Δ_{G} in the z-axis positive direction from 16 μm to 116 μm.

As an Example of the filter device 1A configured as illustrated in FIG. 5, the diameter of each of the openings corresponding to the resonators 10A, 20A, 30A, 40A, and 50A and the diameter of each of the recesses corresponding to the resonators 10A, 20A, 30A, 40A, and 50A (for example, the diameter φ₂₃ of the opening AP3 and the diameter φ_{33A} of the recess 33A in a case of the resonator 30A) were each set to 600 μm, the depth of each of the recesses was set to 100 μm, the inner diameter of each of the cylinders corresponding to the resonators 10A, 20A, 30A, 40A, and 50A (for example, the inner diameter φ₅₃₁ of the cylinder 531 in a case of the resonator 30A) was set to 1000 μm, and the diameter of each of the rods corresponding to the resonators 10A, 20A, 30A, 40A, and 50A (for example, the diameter φ₆₃ of the rod 63 in a case of the resonator 30A) was set to 500 μm. Then, the gap Δ_{G} in the Example of the filter device 1A was set such that Δ_{G}=0 μm, −25 μm, −50 μm, −75 μm, and −100 μm, and the transmission characteristics of the Example of the filter device 1A were simulated. Note that the gap Δ_{G}=−100 μm in the filter device 1A means a state in which the one end surface 63a of the rod 63 protrudes by 100 μm from the first main surface 3Aa of the dielectric substrate 3A into the resonance region of the resonator 30A. (b) of FIG. 6 shows the transmission characteristics of the Example of the filter device 1A.

With reference to (b) of FIG. 6, it was found that the passband of the Example of the filter device 1A can be shifted toward a low frequency side by increasing the gap Δ_{G} in the z-axis negative direction from 0 μm to −100 μm.

Aspects of the present invention can also be expressed as follows:

A filter device in accordance with an aspect of the present invention is a filter device, including: a post-wall waveguide that functions as a resonator group constituted by a plurality of resonators electromagnetically coupled together and that includes: a dielectric substrate; a first conductor layer and a second conductor layer that are a pair of broad walls and provided on a first main surface and a second main surface, respectively, of the dielectric substrate; and a post wall passing through the dielectric substrate and constituted by a conductor post group which is a plurality of conductor posts arranged in a palisade arrangement and via which the first conductor layer and the second conductor layer are in electrical communication with each other, a resonance region of each of the plurality of resonators being formed by the first conductor layer, the second conductor layer, and a part of the dielectric substrate which part is surrounded by the post wall; an opening formed in one of the pair of broad walls of each of at least one resonator belonging to the resonator group; a cavity electromagnetically coupled to each of the at least one resonator via the opening; a rod inserted into the cavity from an end part of the cavity which end part faces away from the opening, at least an end surface of the rod on an opening side being made of a conductor; and a rod control mechanism that controls a gap between the end surface of the rod and a main surface close to the opening.

The filter device is a resonator-coupled filter device in which the plurality of resonators are electromagnetically coupled. Each of the plurality of resonators of the filter device is realized with use of the post-wall waveguide. Further, in the filter device, the rod control mechanism controls the gap between the end surface of the rod and the part of the main surface which part is close to the opening. This makes it possible to change the passband. Specifically, the passband of the filter device can be shifted by increasing the gap. Therefore, the filter device makes it possible to provide a filter device that includes a post-wall waveguide and that has a variable passband.

A filter device in accordance with an aspect of the present invention is preferably configured such that the opening is formed in one of the pair of broad walls of each of all resonators belonging to the resonator group.

With the configuration, it is possible to change the passband while reducing a change in shape of the transmission characteristics of the filter device as compared to a case in which a cavity and an opening are provided for one(s) of the plurality of resonators belonging to the resonator group.

A filter device in accordance with an aspect of the present invention is preferably configured such that the dielectric substrate has, in a position close to at least one of the opening, a recess that is recessed, into the resonance region, from a main surface of the dielectric substrate which main surface faces the at least one of the opening and that has an outer edge within which the end surface of the rod is contained in a plan view.

With the configuration, it is possible to insert the end surface of the rod into the resonance region, the end surface serving as a conductor of the rod. As such, the filter device can change the passband not only by moving the end surface away from the first main surface but also by inserting the end surface into the resonance region. Specifically, the passband of the filter device can be shifted to a high frequency side by moving the end surface in an opposite direction to the direction of the dielectric substrate from the main surface facing the at least one of the opening, and the passband of the filter device can be shifted to a low frequency side by inserting the end surface into the resonance region so as to be away from the main surface facing the at least one of the opening. Therefore, the filter device can change the passband over a wider range as compared to a filter device that only includes resonators having no recess formed therein.

A filter device in accordance with an aspect of the present invention is preferably configured such that the rod control mechanism includes a piezoelectric element that is coupled to the rod and that changes a position of the rod in a uniaxial direction in accordance with a voltage applied to the piezoelectric element.

The piezoelectric element is a solid state component whose volume can be reversibly changed by changing a voltage applied to the respective terminals of the solid state component. Therefore, by controlling a voltage applied to the respective terminals of the piezoelectric element, it is possible to cause the rod control mechanism configured as described above to reversibly change the passband of the filter device.

A filter device in accordance with an aspect of the present invention is preferably configured such that: each of the pair of broad walls of each of the plurality of resonators is in a shape of a circle or in a shape of a regular polygon with six or more vertices; and two resonators, which are coupled together, of the plurality of resonators are arranged such that D<R₁+R₂ is satisfied, where R₁ and R₂ represent radii of circumcircles of the pair of broad walls of the two resonators and D represents a center-to-center distance between the two resonators.

With the configuration, when a focus is paid on two resonators, which are coupled together, of the plurality of resonators, the shape of a combination of the respective circumcircles of the two resonators is symmetric with respect to a line that connects the centers of the two circumcircles together. As such, the filter device has a higher degree of symmetry concerning the shape of the filter device as compared to the filter device disclosed in Patent Literature 1. This makes it possible to reduce the number of design parameters.

Further, with the configuration, the pair of broad walls of the respective plurality of resonators are each in a shape of a circle or in a shape of a regular polygon with six or more vertices. As such, the filter device has a higher degree of symmetry concerning the shape of the filter device as compared to the filter device disclosed in Non-Patent Literature 1. This makes it possible to reduce the number of design parameters.

Thus, the filter device makes it possible to easily design a filter device with desired characteristics as compared to conventional filter devices.

A filter device in accordance with an aspect of the present invention is preferably configured such that the plurality of resonators include a first-pole resonator that has an input port and a last-pole resonator that has an output port, and the plurality of resonators are arranged such that the first-pole resonator and the last-pole resonator are adjacent to each other.

With the configuration, the total length of the filter device can be reduced as compared to when a plurality of resonators are arranged in a straight line.

A filter device in accordance with an aspect of the present invention may be configured such that: each of the pair of broad walls of each of the plurality of resonators is in a shape of a rectangle; and the plurality of resonators are arranged in a straight line.

Supplementary Note

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 1A: filter device
2: conductor layer (first conductor layer)
AP1, AP2, AP3, AP4, AP5: opening
3, 3A: dielectric substrate
33A: recess
4: conductor layer (second conductor layer)
5: block
511 to 551: cylinder (cavity)
531a, 531b: one end part, other end part
61 to 65: rod
63a: one end surface
6P: piezoelectric element (rod control mechanism)
10, 20, 30, 40, 50: resonator

1. A filter device, comprising:
a post-wall waveguide that functions as a resonator group constituted by a plurality of resonators electromagnetically coupled together and that includes:
a dielectric substrate;
a first conductor layer and a second conductor layer that are a pair of broad walls and provided on a first main surface and a second main surface, respectively, of the dielectric substrate; and
a post wall passing through the dielectric substrate and constituted by a conductor post group which is a plurality of conductor posts arranged in a palisade arrangement and via which the first conductor layer and the second conductor layer are in electrical communication with each other, a resonance region of each of the plurality of resonators being formed by the first conductor layer, the second conductor layer, and a part of the dielectric substrate which part is surrounded by the post wall;
an opening formed in one of the pair of broad walls of each of at least one resonator belonging to the resonator group;
a cavity electromagnetically coupled to each of the at least one resonator via the opening;
a rod inserted into the cavity from an end part of the cavity which end part faces away from the opening, at least an end surface of the rod on an opening side being made of a conductor; and
a rod control mechanism that controls a gap between the end surface of the rod and a main surface close to the opening.

2. The filter device as set forth in claim 1, wherein the opening is formed in one of the pair of broad walls of each of all resonators belonging to the resonator group.

3. The filter device as set forth in claim 1, wherein the dielectric substrate has, in a position close to at least one of the opening, a recess that is recessed, into the resonance region, from a main surface of the dielectric substrate which main surface faces the at least one of the opening and that has an outer edge within which the end surface of the rod is contained in a plan view.

4. The filter device as set forth in claim 1, wherein the rod control mechanism includes a piezoelectric element that is coupled to the rod and that changes a position of the rod in a uniaxial direction in accordance with a voltage applied to the piezoelectric element.

5. The filter device as set forth in claim 1, wherein: each of the pair of broad walls of each of the plurality of resonators is in a shape of a circle or in a shape of a regular polygon with six or more vertices; and
two resonators, which are coupled together, of the plurality of resonators are arranged such that D<R₁+R₂ is satisfied, where R₁ and R₂ represent radii of circumcircles of the pair of broad walls of the two resonators and D represents a center-to-center distance between the two resonators.

6. The filter device as set forth in claim 5, wherein the plurality of resonators include a first-pole resonator that has an input port and a last-pole resonator that has an output port, and
the plurality of resonators are arranged such that the first-pole resonator and the last-pole resonator are adjacent to each other.

7. The filter device as set forth in claim 1, wherein: each of the pair of broad walls of each of the plurality of resonators is in a shape of a rectangle; and
the plurality of resonators are arranged in a straight line.
